(19) United States
(12) Patent Application Publication
(10) Pub. No.: US 2016/0193753 A1
(43) Pub. Date: Jul. 7, 2016

(54) TURBOMACHINE AUXILIARY LEAD-THROUGH DEVICE

(71) Applicant: SNECMA, Paris (FR)

(72) Inventor: Nicolas Stoliaroff-Pepin, Moissy-Cramayel (FR)

(21) Appl. No.: 14/892,986

(22) PCT Filed: May 21, 2014
(86) PCT No.: PCT/FR2014/051182

§ 371 Date: Mar. 23, 2016

(30) Foreign Application Priority Data
May 24, 2013 (FR) 1354716

(51) Int. Cl. B29C 33/38; B29D 11/00

(52) U.S. Cl. CPC B29C 33/3878; B29D 11/0048; B29K 2105/0097

(57) ABSTRACT

A lens mold and methods of fabricating such a lens mold are disclosed. The lens mold has a pattern for forming an antireflection structure. With such a lens mold, a lens die can be fabricated with the antireflection structure integrally formed on the exterior thereof. Compared to the prior art, the lens mold allows a lens die to be fabricated directly with an antireflection structure integrally formed therewith in a more reliable manner without the risk of fractures, detachments or other defects. A method of fabricating a lens die is also disclosed.

### CROSS-REFERENCES TO RELATED APPLICATIONS

This application claims the priority of Chinese patent application number 201510141644.7, filed on Mar. 27, 2015, the entire contents of which are incorporated herein by reference.

### TECHNICAL FIELD

The present invention relates to the field of imaging and, in particular, to a lens mold and methods of fabricating such a lens mold, as well as to a method of fabricating a lens die.

### BACKGROUND

With the rapid development of imaging technology, a wide range of imaging devices such as digital cameras and smart phones have become a necessity for people to enjoy their lives. Accordingly, requirements imposed on the performance of such imaging devices are also increasing.

Conventionally, in order to obtain desirable image quality, antireflection coatings for reducing reflections are usually formed on lens dies.

FIG. 1 illustrates a conventional lens having an antireflection coating. The formation of the conventional lens includes providing a substrate 1 and a lens mold (not shown) which has a smooth optical surface portion. With the formation of a convex lens as an example, the lens mold is then used to form a lens die 2 on the substrate 1, followed by vapor deposition carried out in a vapor deposition apparatus, such that an antireflection coating 3 is formed on the lens die 2. Conventionally, vacuum vapor deposition is usually employed to form the antireflection coating 3 on the surface of the lens die 2. The antireflection coating 3 formed in this way are, however, associated with drawbacks such as considerable time consumption, high cost and a long production cycle.

In addition, as shown in FIG. 2, the conventional antireflection coating 3 is formed of a material differing from that of the lens die 2 and is thus less thermally stable and prone to failure 4 caused by fractures, detachments and other defects. This leads to inadequate reliability of the lens die.

For these reasons, there has been an urgent need to improve the conventional lens mold and thereby effectively increase the reliability of the lens die.

### SUMMARY OF THE INVENTION

It is therefore an objective of the present invention to solve the high-cost and low-reliability problems of the conventional lens die by presenting a lens mold, methods of fabricating such a lens mold and a method of fabricating a lens die.

To this end, the present invention provides a method of fabricating a lens mode, which includes: providing a first mold having a surface with a portion resembling a lens surface; forming a pattern for forming an antireflection structure on the surface of the first mold and then forming a first separable layer on the surface of the first mold; and subjecting the surface of the first mold successively to adhesive filling, curing and separation, thereby forming a second mold with the pattern transferred thereto.

Optionally, in the method, the first mold may be a master mold and the second mold may be an intermediate mold, the method further includes: depositing a metal film on the surface of the second mold; and subjecting the surface of the second mold successively to adhesive filling, curing and separation, thereby forming a lens mold with the pattern transferred thereto.

Optionally, the method may further include forming a second separable layer on the surface of the second mold, before the surface of the second mold is subjected to adhesive filling.

Optionally, in the method, forming the pattern for forming the antireflection structure on the surface of the first mold may be accomplished by an electrochemical process comprising: placing the first mold in an acidic oxidizing electrolyte solution to facilitate an anodic oxidation reaction; and processing the first mold in another acidic solution.

Optionally, in the method, the first mold may be a master mold and the second mold is a lens mold.

The present invention also provides another method of fabricating a lens mold, which includes: providing a master mold having a surface with a portion resembling a lens surface; forming a first separable layer on the surface of the master mold; subjecting the surface of the master mold successively to adhesive filling, curing and separation, thereby forming an intermediate mold; depositing a metal film on the surface of the intermediate mold and forming a pattern for forming an antireflection structure on the surface of the metal film; and subjecting the surface of the intermediate mold successively to adhesive filling, curing and separation, thereby forming a lens mold with the pattern transferred thereto.

Optionally, in the method, forming the pattern for forming the antireflection structure on the surface of the metal film may be accomplished by an electrochemical process comprising: placing the master mold in an acidic oxidizing electrolyte solution to facilitate an anodic oxidation reaction; and processing the master mold in another acidic solution.

Optionally, the method may further include forming a second separable layer over the surface of the intermediate mold, before the surface of the intermediate mold is subjected to adhesive filling.

The present invention also provides a further method of fabricating a lens mold, which includes: providing a master mold having a surface with a portion resembling a lens surface; forming a pattern for forming an antireflection structure on the surface of the master mold and then forming a separable layer on the surface of the master mold; providing an auxiliary substrate having a chrome pattern formed thereon; dispensing an adhesive on the chrome pattern of the auxiliary substrate, pressing the master mold onto the auxiliary substrate such that a side of the master mold with the pattern for forming the antireflection structure is bonded to the auxiliary substrate, and performing a curing treatment from a backside of the auxiliary substrate, thereby forming an intermediate mold with the pattern for forming the antireflection structure transferred thereto; and subjecting the surface of the intermediate mold successively to adhesive filling, curing and separation, thereby forming a lens mold with the pattern for forming the antireflection structure transferred thereto.

Optionally, in the method, forming the pattern for forming the antireflection structure on the surface of the master mold may be accomplished by an electrochemical process comprising: placing the master mold in an acidic oxidizing electrolyte solution to facilitate an anodic oxidation reaction; and processing the master mold in another acidic solution.

Optionally, in the method, performing a curing treatment from the backside of the auxiliary substrate may be accomplished by exposure to ultraviolet light.

According to the present invention, the lens mold has a pattern for forming an antireflection structure. With such a lens mold, a lens die can be fabricated with the antireflection structure integrally formed on the exterior thereof. Compared to the prior art, the lens mold according to the present invention allows a lens die to be directly formed with the antireflection structure integrally formed therewith in a significantly more reliable manner without the risk of fractures, detachments or other defects. In addition, according to the present invention, the use of the electrochemical process can result in a reduction in fabrication cost.

### BRIEF DESCRIPTION OF THE DRAWINGS

FIG. 1 is a schematic illustration of a conventional lens.

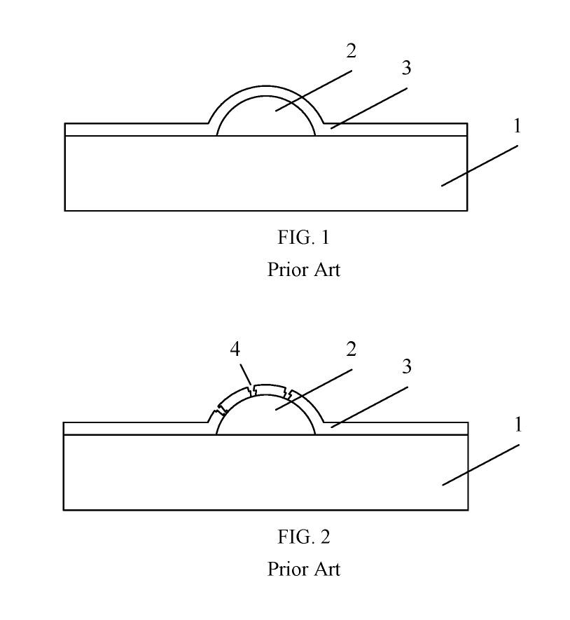

FIG. 2 is a schematic illustration of the conventional lens with defects.

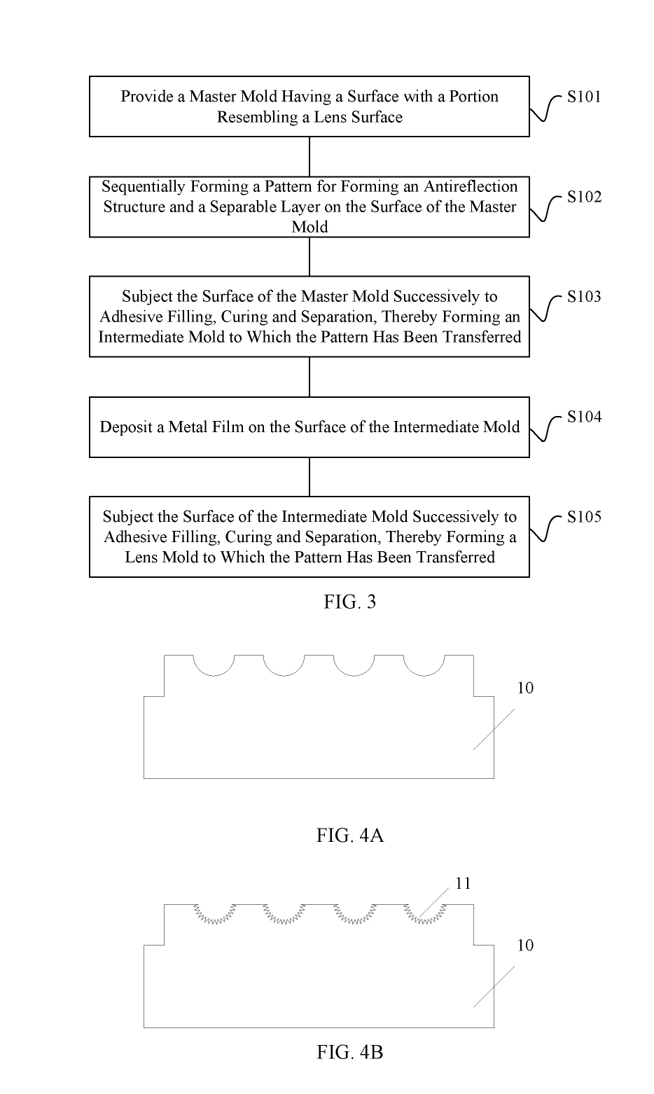

FIG. 3 is a flowchart illustrating a method of fabricating a lens mold in accordance with a first embodiment of the present invention.

FIGS. 4A to 4G illustrate intermediate structures formed during the fabrication of the lens mold according to the first embodiment of the present invention.

FIG. 5 is a flowchart illustrating a method of fabricating a lens mold in accordance with a second embodiment of the present invention.

FIGS. 6A to 6H illustrate intermediate structures formed during the fabrication of the lens mold according to the second embodiment of the present invention.

FIG. 7 is a flowchart illustrating a method of fabricating a lens mold in accordance with a third embodiment of the present invention.

FIGS. 8A to 8D illustrate intermediate structures formed during the fabrication of the lens mold according to the third embodiment of the present invention.

FIG. 9 is a flowchart illustrating a method of fabricating a lens mold in accordance with a fourth embodiment of the present invention.

FIGS. 10A to 10H illustrate intermediate structures formed during the fabrication of the lens mold according to the fourth embodiment of the present invention.

FIG. 11 is a flowchart illustrating a method of fabricating a lens die in accordance with the present invention.

FIGS. 12A to 12D illustrate intermediate structures formed during the fabrication of the lens die according to the present invention.

### DETAILED DESCRIPTION

The present invention will be described in greater detail in the following description which presents preferred embodiments of the invention, in conjunction with the accompanying drawings. It is to be appreciated that those of skill in the art can make changes in the invention disclosed herein while still obtaining the beneficial results thereof. Therefore, the following description shall be construed as being intended to be widely known by those skilled in the art rather than as limiting the invention.

The present invention will be further described in the following paragraphs by way of embodiments with reference to the accompanying drawings. Features and advantages of the invention will be more apparent from the following detailed description, and from the appended claims. Note that the accompanying drawings are provided in a very simplified form not necessarily presented to scale, with the only intention of facilitating convenience and clarity in explaining a few illustrative embodiments of the invention.

The core concept of the present invention is to provide a lens mold and methods of fabricating such a lens mold, as well as a method of fabricating a lens die. The lens mold according to the present invention has a pattern for forming an antireflection structure. With such a lens mold, a lens die can be integrally fabricated with the antireflection structure, thus eliminating the risk of fractures, detachments or other defects occurring. In addition, according to the present invention, the pattern for forming the antireflection structure is obtained from an electrochemical process which includes: placing a master mold in an acidic oxidizing electrolyte solution for an anodic oxidation reaction to take place; and further processing the master mold in another acidic solution. After this process, openings with a certain diameter are densely distributed on the surface of the master mold and form the pattern for forming the antireflection structure. The formation of such a pattern is described in greater detail in the following Embodiments 1 to 4.

The principles of the invention will become more apparent from the following preferred embodiments of the lens mold and its fabrication methods according to the present invention. It is to be understood that the present invention is not limited to these disclosed embodiments, and that modifications made based on ordinary skill in this art also fall within the concept and scope of the invention.

### Embodiment 1

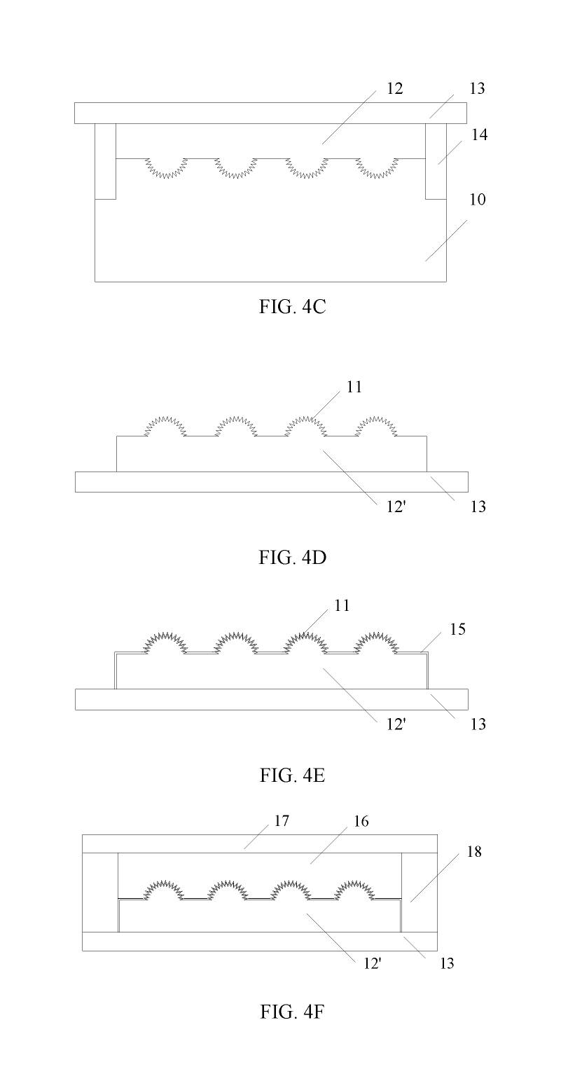

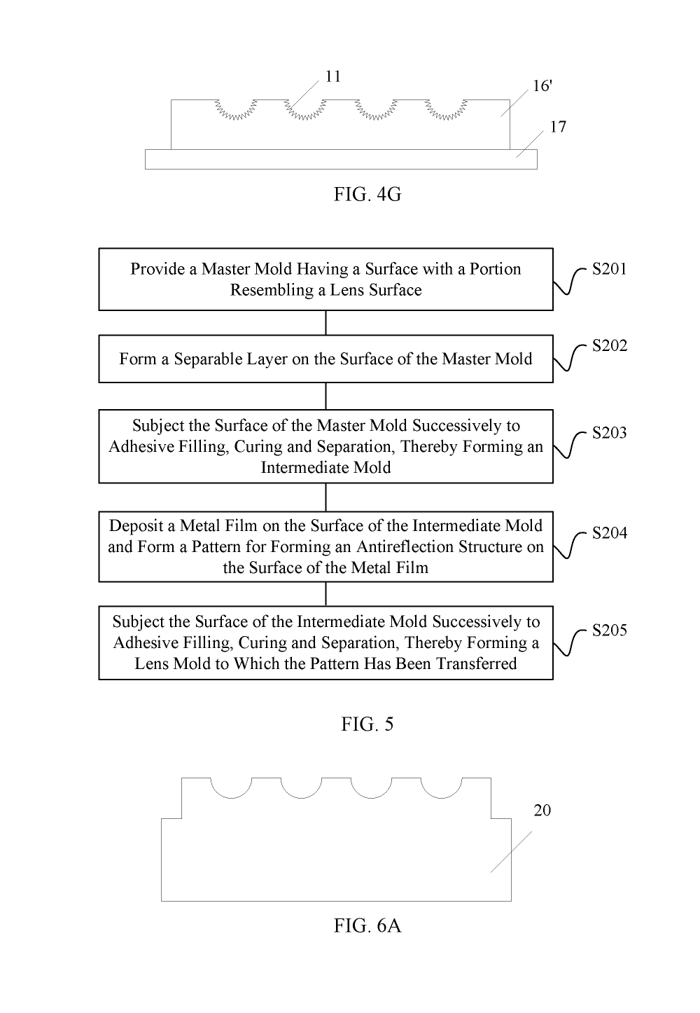

With reference to FIG. 3, in conjunction with FIGS. 4A to 4G, the present invention provides a lens mold and a method of fabricating such a lens mold. FIG. 3 is a flowchart illustrating a method of fabricating a lens mold in accordance with a first embodiment of the present invention, and FIGS. 4A to 4G illustrate intermediate structures formed during the fabrication of the lens mold according to the first embodiment of the present invention.

As shown in FIG. 3, the method according to this embodiment includes the steps described below.

In step S101, a master mold with surface portions resembling lens surfaces is provided. In particular, referring to FIG. 4A, the master mold 10 is preferably a metal mold. For example, the master mold 10 may be selected to be made of aluminum or another metal. As indicated by FIG. 4A, the master mold 10 has surface portions resembling lens surfaces which are, in this embodiment, concave surfaces. For example, each of the surface portions may be part of a circle, specifically, for example, a segment with a maximum height of about 0.5 mm of a circle with a diameter of 2-3 mm. Of course, such details are not provided to limit the surface portions to any particular profile, and the surface portions may have any profile adapted to the practical needs. The surface portions may be formed, for example, by a cutting, grinding or other operation carried out by a numerical control machine tool.

In step S102, patterns for forming antireflection structures and a first separable layer are sequentially formed on the surface of the master mold. Referring to FIG. 4B, the patterns 11 are formed by performing a process on the master mold 10. Preferably, the process may be an electrochemical process. In this embodiment, the patterns 11 are distributed on the respective corresponding concave surfaces. Specifically, the electrochemical process may include: placing the master mold 10 in an acidic oxidizing electrolyte solution (this acidic solution may be an oxalic acid solution or a phosphoric acid solution) for an anodic oxidation reaction to take place so that nano-porous metal oxide arrays are formed on the surface of the master mold 10; and placing the master mold 10 in another acidic solution so that the nano-porous metal oxide arrays are etched away, forming tapered openings each with its end proximal to the surface of the master mold having a larger diameter than the end located deep in the master mold. As a result of the electrochemical process, on each of the concave surface portions, there are formed a number of densely distributed openings each having a diameter of 50-300 nm when viewed along the normal of the corresponding surface portion and a depth of 100-1000 nm, and adjacent openings are spaced from each other by a distance of 100-600 nm. As such, the desired patterns 11 are formed on the master mold 10.

Subsequently, a first separable layer (not shown) is further formed on the master mold 10. The formation of the first separable layer may be accomplished by plasma deposition of, for example, a fluoride. The first separable layer is so thin that it does not clog the openings.

In step S103, the surface of the master mold is subjected successively to adhesive filling, curing and separation, thereby resulting in an intermediate mold to which the patterns for forming the antireflection structures have been transferred. As shown in FIG. 4C, an adhesive 12 is poured over the master mold 10, degassed and covered by a backplane 13. The adhesive 12 may be filled using any method known in this art, for example, a method involving the use of side plates 14 for limiting the adhesive and facilitating its curing. Considering that bubbles may be generated during the pouring of the adhesive 12, a vacuum degasser may be used to eliminate the bubbles within the poured adhesive. The openings of the patterns 11 are filled with the poured adhesive, and after the adhesive 12 has been cured, it is separated therefrom to obtain the intermediate mold 12′, and the patterns 11 have been transferred to the intermediate mold 12′, as shown in FIG. 4D. In this embodiment, the intermediate mold 12′ assumes a convex profile. The intermediate mold 12′ is formed of the cured adhesive and may be used while adhering to the backplane 13. In order to facilitate the subsequent formation of the lens mold, the backplane 13 may extend beyond edges of the intermediate mold 12′. The presence of the first separable layer can ensure that the intermediate mold 12′ is completely separated without defects caused by its adhesions to the master mold 10.

In step S104, a metal film is deposited over the surface of the intermediate mold. Referring to FIG. 4E, the film 15 is deposited on the intermediate mold 12′. Preferably, the film 15 is aluminum, and of course, it may also be another metal. In order for the film 15 to have high quality, the deposition may be performed by a vacuum sputtering machine in a high vacuum environment. In addition, in order to obtain better conformity to the profile of the patterns 11, the film 15 has a thickness of 1-10 μm. As such, the intermediate mold 12′ is coated with the film 15 and has the desired patterns 11. Those skilled in the art can obtain patterns 11 with other desired characteristics by controlling the reaction conditions according to their needs.

Preferably, after the film 15 is deposited on the intermediate mold 12′, a second separable layer (not shown) is further formed on the intermediate mold 12′. The second separable layer is also so thin that it does not clog the openings of the patterns 11 and may be formed using the same method as the first separable layer.

In step S105, the intermediate mold is subjected successively to adhesive filling, curing and separation, thereby forming the lens mold to which the patterns have been transferred. As shown in FIG. 4F, an adhesive 16 is poured over the intermediate mold 12′ and degassed. With similarity to step S103, this may also involve the use of side plates 18, a vacuum degasser and a backplane 17. The adhesive 16 is preferably a silicone or resinous material, and the volume of the poured adhesive may be selected according to the practical needs. With the adhesive 16 having been poured, the openings of the patterns are filled therewith. As shown in FIG. 4G, after the adhesive 16 has been cured, the adhesive 16 is separated from the intermediate mold 12′ so that the patterns 11 are transferred to the cured adhesive, i.e., the intended lens mold 16′. The presence of the second separable layer can ensure that the lens mold 16′ is well separated from the intermediate mold 12′ without fractures occurring in its portions located within the openings.

With the completion of the above steps, the lens mold according to this embodiment is formed. The patterns for forming antireflection structures are formed on the surface of the lens mold. With these patterns, lens dies can be directly formed with the antireflection structures, thus eliminating the risk of fractures, detachments or other defects occurring.

### Embodiment 2

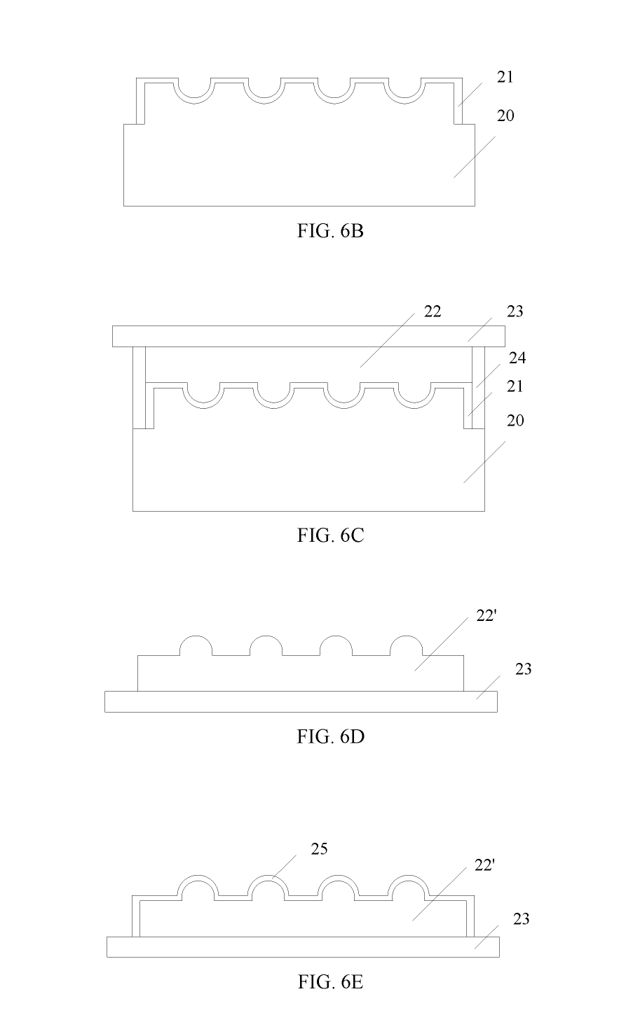

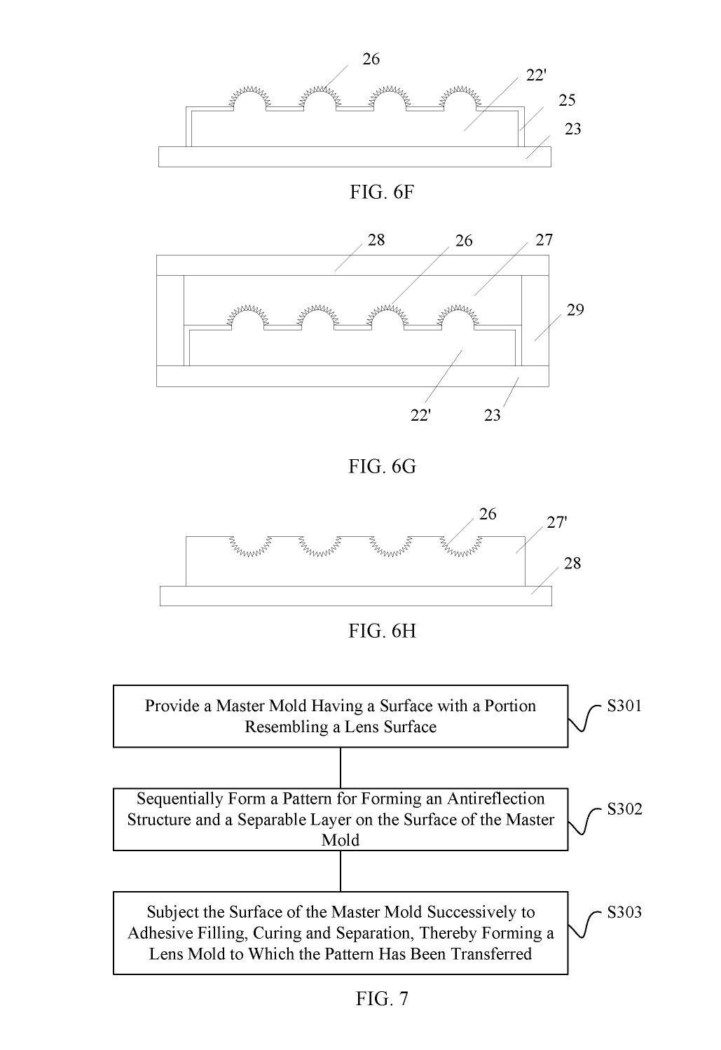

With reference to FIG. 5, in conjunction with FIGS. 6A to 6H, the present invention provides a lens mold and a method of fabricating such a lens mold. FIG. 5 is a flowchart illustrating a method of fabricating a lens mold in accordance with a second embodiment of the present invention, and FIGS. 6A to 6H illustrate intermediate structures formed during the fabrication of the lens mold according to the second embodiment of the present invention.

As shown in FIG. 5, the method according to this embodiment includes the steps described below.

In step S201, a master mold with surface portions resembling lens surfaces is provided. In particular, referring to FIG. 6A, the master mold 20 is preferably a metal mold. For example, the master mold 20 may be selected to be fabricated from aluminum or another metal. As indicated by FIG. 6A, the master mold 20 has surface portions resembling lens surfaces which are, in this embodiment, concave surfaces. For example, each of the surface portions may be part of a circle, specifically, for example, a segment with a maximum height of about 0.5 mm of a circle with a diameter of 2-3 mm. Of course, such details are not provided to limit the surface portions to any particular profile, and the surface portions may have any profile adapted to the practical needs. The surface portions may be formed, for example, by a cutting, grinding or other operation carried out by a numerical control machine tool.

In step S202, a first separable layer is formed on the surface of the master mold. Referring to FIG. 6B, a first separable layer 21 is formed on the master mold 20. The formation of the first separable layer 21 may be accomplished by plasma deposition of, for example, a fluoride.

In step S203, the surface of the master mold is subjected successively to adhesive filling, curing and separation, thereby resulting in an intermediate mold. As shown in FIG. 6C, an adhesive 22 is poured over the master mold 20, degassed and covered by a backplane 23. The adhesive 22 may be filled using any method known in this art, for example, a method involving the use of side plates 24 for limiting the adhesive and facilitating its curing. Considering that bubbles may be generated during the pouring of the adhesive 22, a vacuum degasser may be used to eliminate the bubbles within the poured adhesive. After the adhesive 22 has been cured, it is separated to obtain the intermediate mold 22′, as shown in FIG. 6D. In this embodiment, the intermediate mold 22′ assumes a convex profile. The intermediate mold 22′ is formed of the cured adhesive 22 and may be used while adhering to the backplane 23. In order to facilitate the subsequent formation of the lens mold, the backplane 23 may extend beyond edges of the intermediate mold 22′. The presence of the first separable layer 21 can ensure that the intermediate mold 22′ is completely separated without defects caused by its adhesions to the master mold 20.

In step S204, a metal film is deposited over the surface of the intermediate mold, and patterns for forming antireflection structures are formed on the surface of the metal film. Referring to FIG. 6E, the film 25 is deposited on the intermediate mold 22′. Preferably, the film 25 is aluminum, and of course, it may also be another metal. In order for the film 25 to have high quality, the deposition may be performed by a vacuum sputtering machine in a high vacuum environment. The film 25 may have a thickness of 1-10 μm. Following the deposition of the film 25, as shown in FIG. 6F, the film 25 undergoes a process which results in the desired patterns 26 for forming antireflection structures. Preferably, the process may be an electrochemical process. Specifically, the electrochemical process may include: placing the master mold 20 in an acidic oxidizing electrolyte solution (this acidic solution may be a an oxalic acid solution or a phosphoric acid solution) for an anodic oxidation reaction to take place so that nano-porous metal oxide arrays are formed on the surface of the master mold 20; and placing the master mold 20 in another acidic solution so that the nano-porous metal oxide arrays are etched away, forming tapered openings each with its end proximal to the surface of the master mold having a larger diameter than the end located deep in the master mold. As a result of the electrochemical process, on each of the convex surface portions, there are formed a number of densely distributed openings each having a diameter of 50-300 nm when viewed along the normal of the corresponding surface portion and a depth of 100-1000 nm, and adjacent openings are spaced from each other by a distance of 100-600 nm. As such, the desired patterns 26 are formed on the master mold 20. Those skilled in the art can obtain patterns 26 with other desired characteristics by controlling the reaction conditions according to their needs.

Preferably, a second separable layer (not shown) is further formed on the intermediate mold 22′ on which the patterns 26 have already been formed. The second separable layer is so thin that it does not clog the openings of the patterns 26 and may be formed using the same method as the first separable layer.

In step S205, the intermediate mold is subjected successively to adhesive filling, curing and separation, thereby forming the lens mold to which the patterns have been transferred. As shown in FIG. 6G, an adhesive 27 is poured over the intermediate mold 22′ and degassed. With similarity to step S203, this may also involve the use of side plates 29, a vacuum degasser and a backplane 28. The adhesive 27 is preferably a silicone or resinous material, and the volume of the poured adhesive may be selected according to the practical needs. With the adhesive 27 having been poured, the openings of the patterns 26 are filled therewith. As shown in FIG. 6H, after the adhesive 27 has been cured, the adhesive 27 is separated from the intermediate mold 22′ so that the patterns 26 are transferred to the cured adhesive, i.e., the target lens mold 27′. The presence of the second separable layer can ensure that the lens mold 27′ is well separated from the intermediate mold 22′ without fractures occurring in its portions located within the openings.

With the completion of the above steps, the lens mold according to this embodiment is formed. The patterns for forming antireflection structures are formed on the surface of the lens mold. With these patterns, lens dies can be directly formed with the antireflection structures, thus eliminating the risk of fractures, detachments or other defects occurring.

### Embodiment 3

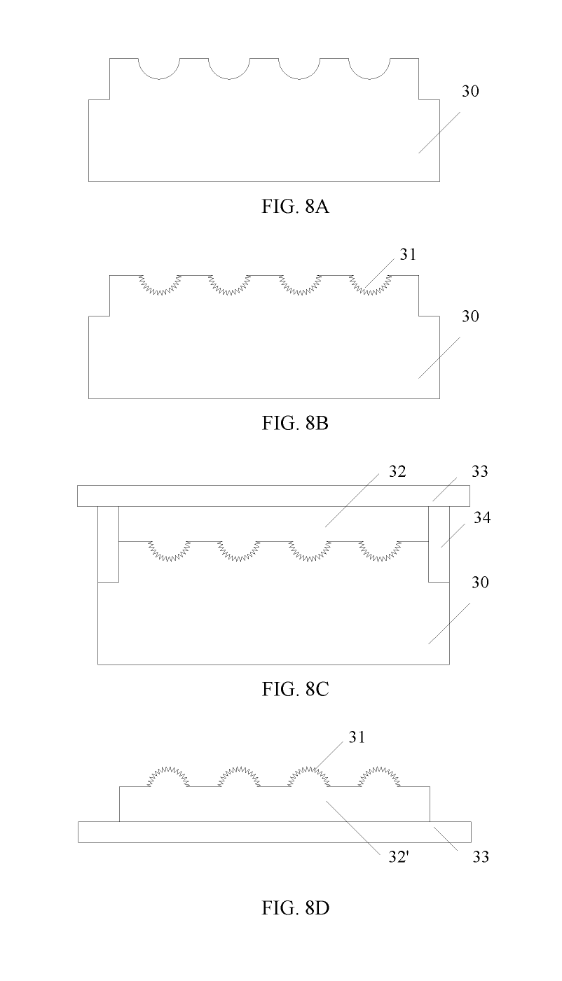

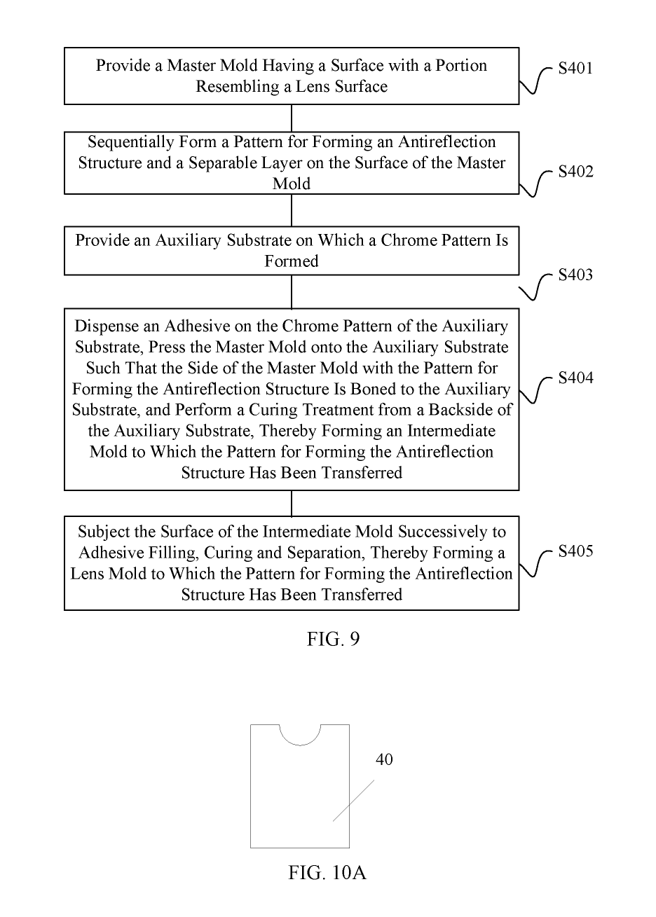

With reference to FIG. 7, in conjunction with FIGS. 8A to 8D, the present invention provides a lens mold and a method of fabricating such a lens mold. FIG. 7 is a flowchart illustrating a method of fabricating a lens mold in accordance with a third embodiment of the present invention, and FIGS. 8A to 8D illustrate intermediate structures formed during the fabrication of the lens mold according to the third embodiment of the present invention.

As shown in FIG. 7, the method according to this embodiment includes the steps described below.

In step S301, a master mold with surface portions resembling lens surfaces is provided. In particular, referring to FIG. 8A, the master mold 30 is preferably a metal mold. For example, the master mold 30 may be selected to be made of aluminum or another metal. As indicated by FIG. 8A, the master mold 30 has surface portions resembling lens surfaces which are, in this embodiment, concave surfaces. For example, each of the surface portions may be part of a circle, specifically, for example, a segment with a maximum height of about 0.5 mm of a circle with a diameter of 2-3 mm. Of course, such details are not provided to limit the surface portions to any particular profile, and the surface portions may have any profile adapted to the practical needs. The surface portions may be formed, for example, by a cutting, grinding or other operation carried out by a numerical control machine tool.

In step S302, patterns for forming antireflection structures and a separable layer are sequentially formed on the surface of the master mold. Referring to FIG. 8B, the patterns 31 are formed by performing a process on the master mold 30. Preferably, the process may be an electrochemical process. Specifically, the electrochemical process may include: placing the master mold 30 in an acidic oxidizing electrolyte solution (this acidic solution may be an oxalic acid solution or a phosphoric acid solution) for an anodic oxidation reaction to take place so that nano-porous metal oxide arrays are formed on the surface of the master mold 30; and placing the master mold 30 in another acidic solution so that the nano-porous metal oxide arrays are etched away, forming tapered openings each with its end proximal to the surface of the master mold having a larger diameter than the end located deep in the master mold. As a result of the electrochemical process, on each of the concave surface portions, there are formed a number of densely distributed openings each having a diameter of 50-300 nm when viewed along the normal of the surface portion and a depth of 100-1000 nm, and adjacent openings are spaced from each other by a distance of 100-600 nm. As such, the desired patterns 31 are formed on the master mold 30. Those skilled in the art can obtain patterns 31 with other desired characteristics by controlling the reaction conditions according to their needs.

Subsequently, a separable layer (not shown) is further formed over the master mold 30. The formation of the separable layer may be accomplished by plasma deposition of, for example, a fluoride. The separable layer is so thin that it does not clog the openings.

In step S303, the surface of the master mold is subjected successively to adhesive filling, curing and separation, thereby resulting in the lens mold to which the patterns for forming the antireflection structures have been transferred. As shown in FIG. 8C, an adhesive 32 is poured over the master mold 30, degassed and covered by a backplane 33. The adhesive 32 may be filled using any method known in this art, for example, a method involving the use of side plates 34 for limiting the adhesive and facilitating its curing. Considering that bubbles may be generated during the pouring of the adhesive 32, a vacuum degasser may be used to eliminate the bubbles within the poured adhesive. The openings of the patterns 31 are filled with the poured adhesive, and after the adhesive 32 has been cured, it is separated therefrom to obtain the lens mold 32′, and the patterns 31 have been transferred to the intermediate mold 32′, as shown in FIG. 8D. In this embodiment, the lens mold 32′ assumes a convex profile and can thus be used to produce concave lenses. The lens mold 32′ is formed of the cured adhesive and may be used while adhering to the backplane 33. The presence of the separable layer can ensure that the lens mold 32′ is completely separated without defects caused by its adhesions to the master mold 30.

With the completion of the above steps, the lens mold according to this embodiment is formed. The patterns for forming antireflection structures are formed on the surface of the lens mold. With these patterns, lenses can be directly formed with the antireflection structures, thus eliminating the risk of fractures, detachments or other defects occurring. The lens mold according to this embodiment differs from those of the above-described two embodiments that it can be used to produce concave lenses.

### Embodiment 4

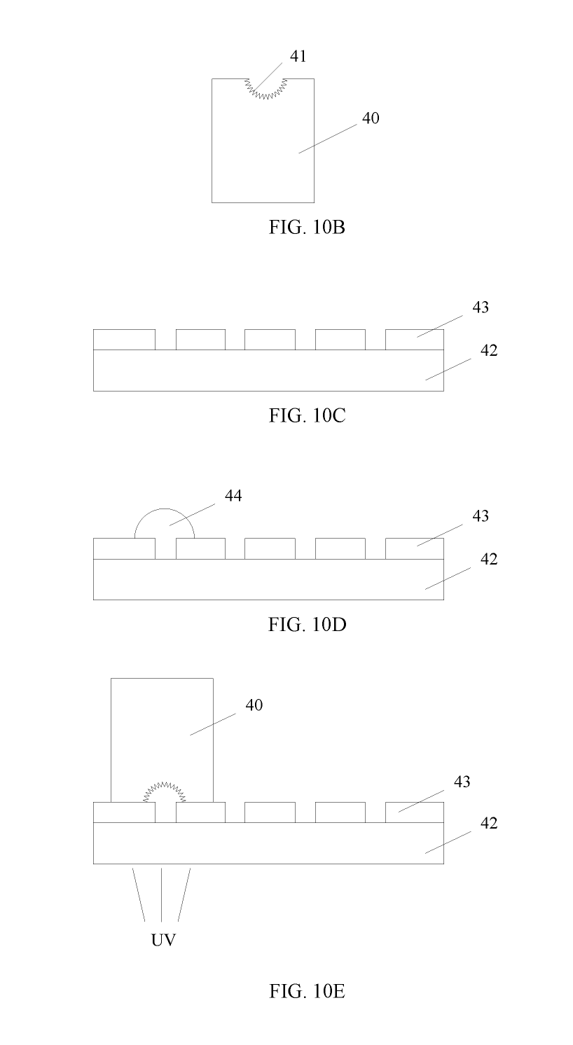

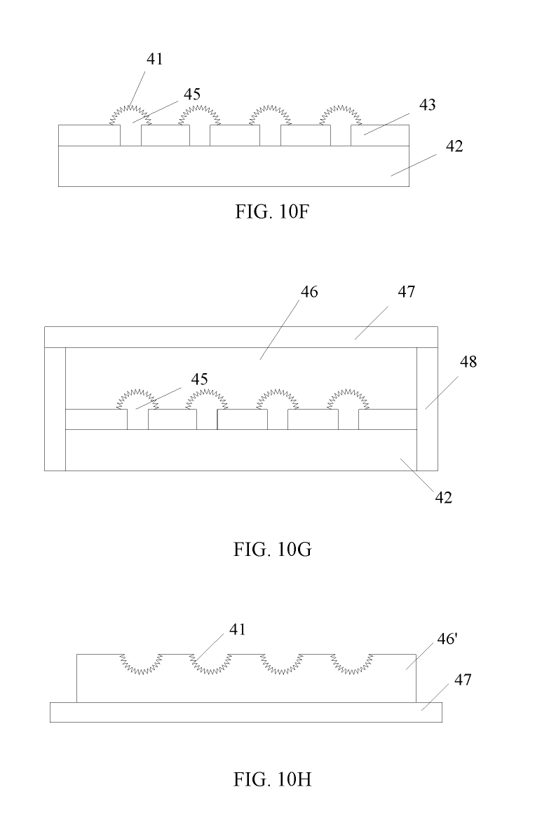

With reference to FIG. 9, in conjunction with FIGS. 10A to 10H, the present invention provides a lens mold and a method of fabricating such a lens mold. FIG. 9 is a flowchart illustrating a method of fabricating a lens mold in accordance with a fourth embodiment of the present invention, and FIGS. 10A to 10H illustrate intermediate structures formed during the fabrication of the lens mold according to the fourth embodiment of the present invention.

As shown in FIG. 9, the method according to this embodiment includes the steps described below.

In step S401, a master mold with a surface portion resembling a lens surface is provided. In particular, referring to FIG. 10A, the master mold 40 is preferably a metal mold. For example, the master mold 40 may be selected to be made of aluminum or another metal. In this embodiment, there is only one surface portion which is a concave surface. For example, this surface portion may be part of a circle, specifically, for example, a segment with a maximum height of about 0.5 mm of a circle with a diameter of 2-3 mm. Of course, such details are not provided to limit the surface portion to any particular profile, and the surface portion may have any profile adapted to the practical needs. The surface portion may be formed, for example, by a cutting, grinding or other operation carried out by a numerical control machine tool.

In step S402, a pattern for forming an antireflection structure and a separable layer are sequentially formed on the surface of the master mold. Referring to FIG. 10B, the master mold 40 is subjected to a process which results in the pattern 41. Preferably, the process may be an electrochemical process. Specifically, the electrochemical process may include: placing the master mold 40 in an acidic oxidizing electrolyte solution (this acidic solution may be a an oxalic acid solution or a phosphoric acid solution) for an anodic oxidation reaction to take place so that a nano-porous metal oxide array is formed on the surface of the master mold 40; and placing the master mold 40 in another acidic solution so that the nano-porous metal oxide array is etched away, forming tapered openings each with its end proximal to the surface of the master mold having a larger diameter than the end located deep in the master mold. As a result of the electrochemical process, on the concave surface portion, there are formed a number of densely distributed openings each having a diameter of 50-300 nm when viewed along the normal of the surface portion and a depth of 100-1000 nm, and adjacent openings are spaced from each other by a distance of 100-600 nm. As such, the desired pattern 41 is formed on the master mold 40. Those skilled in the art can obtain a pattern 41 with other desired characteristics by controlling the reaction conditions according to their needs.

Subsequently, a separable layer (not shown) is further formed on the master mold 40. The formation of the separable layer may be accomplished by plasma deposition of, for example, a fluoride. The separable layer is so thin that it does not clog the openings.

In step S403, an auxiliary substrate is provided on which there is formed a chrome pattern. Referring to FIG. 10C, the auxiliary substrate may be implemented as a glass substrate 42 having a front side on which the chrome pattern 43 that meets the design requirements is formed by, for example, photolithography and etching processes.

In step S404, an adhesive is dispensed on the chrome pattern of the auxiliary substrate, and the master mold is pressed onto the auxiliary substrate, such that the side of the master mold with the patterns for forming the antireflection structure is bonded to the auxiliary substrate. After that, a curing treatment is carried out from a backside of the auxiliary substrate, thereby forming an intermediate mold to which the antireflection structure forming pattern has been transferred. Referring to FIGS. 10D to 10E, a dispenser may be used to dispense the adhesive 44 on the chrome pattern 43. With the dispensation being completed, the master mold 40 is immediately pressed onto the adhesive 44, followed by a curing treatment. Due to the use of, for example, the glass substrate 42, the adhesive 44 may be cured by exposure to ultraviolet (UV) light, and the degree of curing may be controlled by adjusting the UV light intensity and exposure time. After the curing of the adhesive 44 is completed, the master mold 40 may be moved successively to allow the above steps to be repeated on its other locations until a required number of adhesive dies are formed on the chrome pattern 43, thereby forming the intermediate mold 45, as shown in FIG. 10F. As indicated by FIG. 10F, after the curing treatment, the pattern 41 of the master mold 40 has been transferred to the intermediate mold 45, with the intermediate mold 45 being bonded to the auxiliary substrate.

Preferably, with the intermediate mold 45 having been formed, a rinsing process using an organic solvent (e.g., heptanedione) may be carried out to remove uncured portions of the adhesive.

In step S405, the surface of the intermediate mold is subjected successively to adhesive filling, curing and separation, thereby forming the lens mold to which the antireflection structure forming pattern has been transferred. As shown in FIG. 10G, an adhesive 46 is poured over the intermediate mold 45 and degassed. With similarity to the foregoing embodiments, this may also involve the use of side plates 48, a vacuum degasser and a backplane 47. The adhesive 46 is preferably a silicone or resinous material, and the volume of the poured adhesive may be selected according to the practical needs. With the adhesive 46 having been poured, the openings of the pattern 41 are filled therewith. As shown in FIG. 10H, after the adhesive 46 has been cured, the adhesive 46 is separated from the intermediate mold 45 so that the pattern 41 is transferred to the cured adhesive, i.e., the target lens mold 46′.

With the completion of the above steps, the lens mold according to this embodiment is formed. The patterns for forming antireflection structures are formed on the surface of the lens mold. With these patterns, lenses can be directly formed with the antireflection structures, thus eliminating the risk of fractures, detachments or other defects occurring.

### Embodiment 5

Four preferred embodiments of the lens mold and its fabrication methods according to the present invention have been presented above. The present invention also provides a method of fabricating a lens die based on the prepared lens mold.

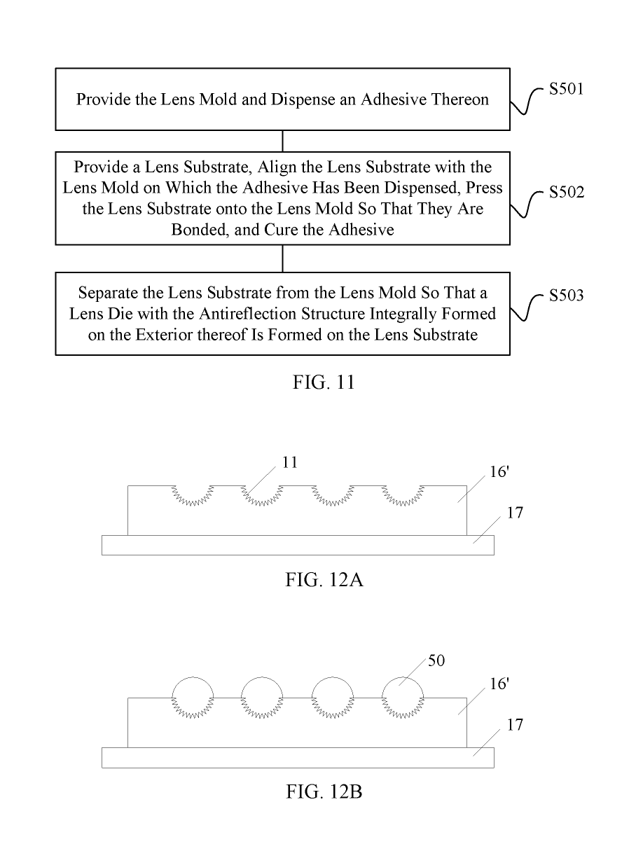

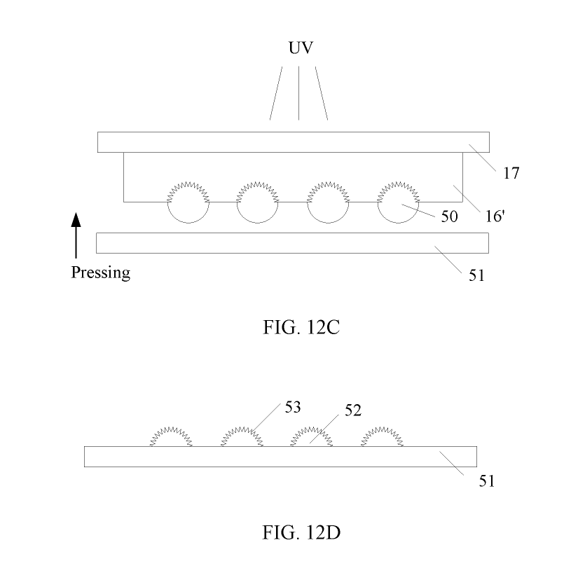

With reference to FIG. 11, in conjunction with FIGS. 12A to 12D, the present invention provides a method of fabricating a lens mold. FIG. 11 is a flowchart illustrating a method of fabricating a lens mold in accordance with the present invention, and FIGS. 12A to 12D illustrate intermediate structures formed during the fabrication of the lens die according to the present invention.

As shown in FIG. 11, the method according to this embodiment includes the steps described below.

In step S501, a lens mold prepared according to one of the previous embodiments is provided, and an adhesive is dispensed thereon. Referring to FIG. 12A, in this embodiment, the lens mold 16′ made in accordance with Embodiment 1 is use, and reference can be made to Embodiment 1 for details of its preparation and structure. However, it is a matter of course that the use of the lens mold 16′ is only for illustrating the fabrication of a lens die in accordance with the present invention.

Referring to FIG. 12B, the adhesive is dispensed on the lens mold 16′. Specifically, The adhesive 50 is dispensed on the concave surface portions in which the antireflection structure forming patterns 11 are formed. As shown in FIG. 12B, the dispensed adhesive 50 fills the openings in the patterns 11. This process can be performed using a dispenser, and the adhesive 50 may be a silicone or resinous material. The positioning and amount of the used adhesive is well known to those skilled in the art, and detailed description of it is therefore omitted herein.

In step S502, a lens substrate is provided and is aligned with the lens mold where the adhesive has been dispensed on. The lens substrate is then pressed so that it is bonded to the lens mold, followed by curing of the adhesive. Referring to FIG. 12C, the lens substrate 51 may be selected as a glass substrate that has been subjected to pre-processing such as cleaning. The lens substrate 51 is pressed and thereby bonded to the lens mold 16′ on which the adhesive has been dispensed, and the adhesive is then cured. The curing may be accomplished by UV light irradiation from a backside (i.e., the side more distant from the lens mold 16′) of the backplane 17, and the degree of curing may be controlled according to the practical needs by adjusting the UV light intensity and irradiation time.

In step S503, the lens substrate is separated from the lens mold, with lens dies being formed on the lens substrate and each of the lens dies having an antireflection structure integrally formed on its exterior. Referring to FIG. 12D, after the adhesive has been cured, the lens substrate 51 is separated from the lens mold 16′, with the pressed and cured adhesive forming the lens dies 52 which are bonded to the lens substrate 51. With the completion of the above steps, the fabrication of the lens die according to the present invention is completed. As the lens mold 16′ has the patterns 16, an antireflection structure 53 is formed on the exterior of each lens die 52. Specifically, each antireflection structure 53 has a number of protrusions with a diameter of 50-300 nm, and adjacent protrusions are spaced from each other by a distance of 100-600 nm. In addition, each antireflection structure has a thickness of 100-1000 nm and forms part of the corresponding lens die 52. That is, the antireflection structure is integrated with the lens die into one piece and is thus unlikely to suffer from fractures, detachments or other defects.

In addition, morphological and positional measurements may be carried out on the lens dies when required.

In summary, according to the present invention, a lens mold and lens die can be fabricated in a simple manner with low cost. In addition, according to the present invention, a lens die can be fabricated with an antireflection structure integrally formed therewith, which enables elimination of the risk of fractures, detachments or other defects and a significant improvement in the reliability of the lens die.

Obviously, those skilled in the art can make various modifications and alterations without departing from the spirit and scope of the invention. It is therefore intended that the invention be construed as including all such modifications and alterations insofar as they fall within the scope of the appended claims or equivalents thereof.

What is claimed is:

1. A method of fabricating a lens mold, comprising:
providing a first mold having a surface with a portion resembling a lens surface;
forming a pattern for forming an antireflection structure on the surface of the first mold and then forming a first separable layer on the surface of the first mold; and
subjecting the surface of the first mold successively to adhesive filling, curing and separation, thereby forming a second mold with the pattern transferred thereto.

2. The method of claim 1, wherein the first mold is a master mold and the second mold is an intermediate mold, the method further comprising:
depositing a metal film on the surface of the second mold; and
subjecting the surface of the second mold successively to adhesive filling, curing and separation, thereby forming a lens mold with the pattern transferred thereto.

3. The method of claim 2, further comprising forming a second separable layer on the surface of the second mold, before the surface of the second mold is subjected to adhesive filling.

4. The method of claim 1, wherein forming the pattern for forming the antireflection structure on the surface of the first mold is accomplished by an electrochemical process comprising: placing the first mold in an acidic oxidizing electrolyte solution to facilitate an anodic oxidation reaction; and processing the first mold in another acidic solution.

5. The method of claim 1, wherein the first mold is a master mold and the second mold is a lens mold.

6. A method of fabricating a lens mold, comprising:
providing a master mold having a surface with a portion resembling a lens surface;
forming a first separable layer on the surface of the master mold;
subjecting the surface of the master mold successively to adhesive filling, curing and separation, thereby forming an intermediate mold;
depositing a metal film on the surface of the intermediate mold and forming a pattern for forming an antireflection structure on the surface of the metal film; and
subjecting the surface of the intermediate mold successively to adhesive filling, curing and separation, thereby forming a lens mold with the pattern transferred thereto.

7. The method of claim 6, wherein forming the pattern for forming the antireflection structure on the surface of the metal film is accomplished by an electrochemical process comprising: placing the master mold in an acidic oxidizing electrolyte solution to facilitate an anodic oxidation reaction; and processing the master mold in another acidic solution.

8. The method of claim 6, further comprising forming a second separable layer over the surface of the intermediate mold, before the surface of the intermediate mold is subjected to adhesive filling.

9. A method of fabricating a lens mold, comprising:
providing a master mold having a surface with a portion resembling a lens surface;
forming a pattern for forming an antireflection structure on the surface of the master mold and then forming a separable layer on the surface of the master mold;
providing an auxiliary substrate having a chrome pattern formed thereon;
dispensing an adhesive on the chrome pattern of the auxiliary substrate, pressing the master mold onto the auxiliary substrate such that a side of the master mold with the pattern for forming the antireflection structure is bonded to the auxiliary substrate, and performing a curing treatment from a backside of the auxiliary substrate, thereby forming an intermediate mold with the pattern for forming the antireflection structure transferred thereto; and
subjecting the surface of the intermediate mold successively to adhesive filling, curing and separation, thereby forming a lens mold with the pattern for forming the antireflection structure transferred thereto.

10. The method of claim 9, wherein forming the pattern for forming the antireflection structure on the surface of the master mold is accomplished by an electrochemical process comprising: placing the master mold in an acidic oxidizing electrolyte solution to facilitate an anodic oxidation reaction; and processing the master mold in another acidic solution.

11. The method of claim 9, wherein performing a curing treatment from the backside of the auxiliary substrate is accomplished by exposure to ultraviolet light.
